(19) United States
(12) Patent Application Publication
(10) Pub. No.: US 2022/0333602 A1
(43) Pub. Date: Oct. 20, 2022

(54) COMPRESSOR WITH OPTIMIZED INTERSTAGE FLOW INLET

(71) Applicant: Johnson Controls Tyco IP Holdings LLP, Milwaukee, WI (US)

(72) Inventor: Florin Iancu, Silver Spring, MD (US)

(21) Appl. No.: 17/634,517

(22) PCT Filed: Aug. 11, 2020
(86) PCT No.: PCT/US2020/045712

§ 371 Date: Feb. 10, 2022

Related U.S. Application Data
(60) Provisional application No. 62/885,563, filed on Aug. 12, 2019.

(51) Int. Cl. F04D 17/12; F04D 29/44; F04D 29/46

(52) U.S. Cl. CPC F04D 17/12; F04D 29/444; F04D 29/462

(57) ABSTRACT

A compressor is provided. The compressor includes a first stage portion with a first impeller assembly and a first diffuser assembly, a second stage portion with a second impeller assembly and a second diffuser assembly, and an interstage portion situated between the first stage portion and the second stage portion. The interstage portion includes a directing vane assembly, a collector passage surrounding the directing vane assembly, and a circumferential insertion slot fluidly coupling the collector passage to the directing vane assembly.

### CROSS-REFERENCE TO RELATED APPLICATION

This application claims the benefit of and priority to U.S. Provisional Patent Application No. 62/885,563 filed Aug. 12, 2019, the entire disclosure of which is incorporated by reference herein.

### BACKGROUND

Buildings can include heating, ventilation and air conditioning (HVAC) systems.

### SUMMARY

At least one aspect is directed to a compressor. The compressor can include a first stage portion with a first impeller assembly and a first diffuser assembly, a second stage portion with a second impeller assembly and a second diffuser assembly, and an interstage portion situated between the first stage portion and the second stage portion. The interstage portion can include a directing vane assembly, a collector passage surrounding the directing vane assembly, and a circumferential insertion slot fluidly coupling the collector passage with the directing vane assembly.

### BRIEF DESCRIPTION OF THE DRAWINGS

FIG. 1 is a perspective view drawing of a chiller assembly, according to some embodiments,

FIG. 2 is a side elevation view drawing of the chiller assembly of FIG. 1, according to some embodiments.

FIG. 3 is a perspective view drawing of a multistage compressor which can be utilized with the chiller assembly of FIG. 1, according to some embodiments.

FIG. 4 is a top elevation view drawing of the multistage compressor of FIG. 3, according to some embodiments.

FIG. 5 is a side cross-sectional view drawing of the multistage compressor of FIG. 3, according to some embodiments.

FIGS. 6A-6D are additional side cross-sectional view drawings of the multistage compressor of FIG. 3, according to some embodiments.

FIG. 7 is a perspective view of a directing vane assembly which can be utilized with the multistage compressor of FIG. 3, according to some embodiments.

FIG. 8 is a front cross-sectional view drawing of the directing valve assembly of FIG. 7, according to some embodiments.

FIG. 9 is perspective cross-sectional view drawing of another embodiment of an interstage return channel assembly that can be utilized in the multistage compressor of FIG. 3, according to some embodiments.

FIG. 10 is a plot depicting circumferential pressure distribution test data of the multistage compressor of FIG. 3, according to some embodiments.

### DETAILED DESCRIPTION

Referring generally to the FIGURES, a chiller assembly with a multistage centrifugal compressor having an optimized interstage flow inlet is shown. Centrifugal compressors are useful in a variety of devices that require a fluid to be compressed, such as chillers. In order to effect this compression, centrifugal compressors utilize rotating components in order to convert angular momentum to static pressure rise in the fluid.

A single stage centrifugal compressor can include four main components: an inlet, an impeller, a diffuser, and a collector or volute. The inlet can include a simple pipe that draws fluid (e.g., a refrigerant) into the compressor and delivers the fluid to the impeller. The impeller is a rotating set of vanes that gradually raises the energy of the fluid as it travels from the center of the impeller (also known as the eye of the impeller) to the outer circumferential edges of the impeller (also known as the tip of the impeller). Downstream of the impeller in the fluid path is the diffuser mechanism, which acts to decelerate the fluid and thus convert the kinetic energy of the fluid into static pressure energy. Upon exiting the diffuser, the fluid enters the collector or volute, where further conversion of kinetic energy into static pressure occurs due to the shape of the collector or volute.

Multistage centrifugal compressors can include multiple inlets, impellers, and diffusers. As compared with a single stage compressor, a multistage compressor is able to achieve a higher overall pressure ratio, and better refrigeration cycle performance due to the presence of an economizer, as described in further detail below. A two stage centrifugal compressor may operate as follows: a main flow of fluid may flow through a first inlet, impeller, and diffuser assembly. Upon exiting the first diffuser assembly, the main flow of fluid may combine with a second flow of fluid entering the compressor through a second inlet. The combined main and secondary flow then travels through a second impeller and diffuser assembly before exiting the compressor through a collector or volute. Rather than dumping the secondary flow at the top of a return channel or injecting it at discrete points in the main flow (both of which are aerodynamically disruptive to the main fluid flow), the embodiments of the present disclosure include a collector cavity fluidly coupled to the secondary flow inlet. The collector cavity permits the secondary flow to be uniformly distributed before being inserted into the main flow path, resulting in improved compressor performance.

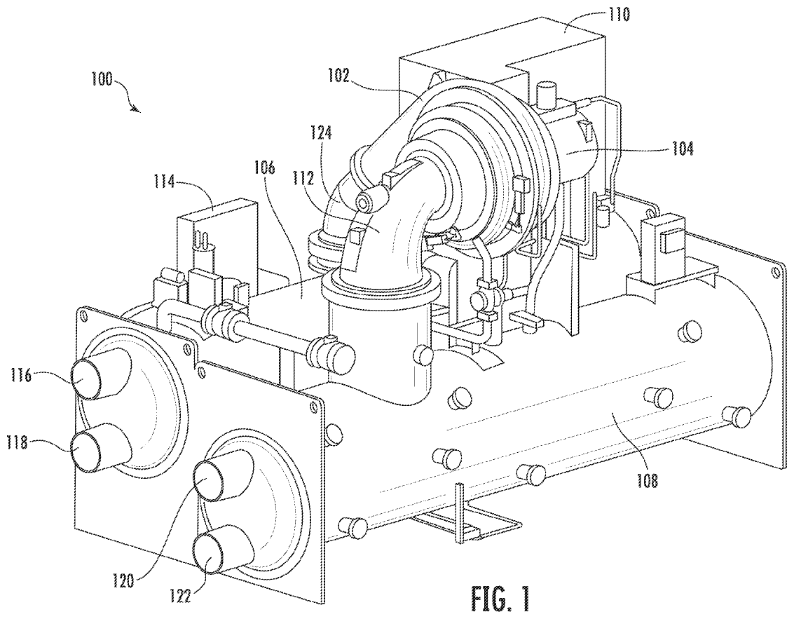

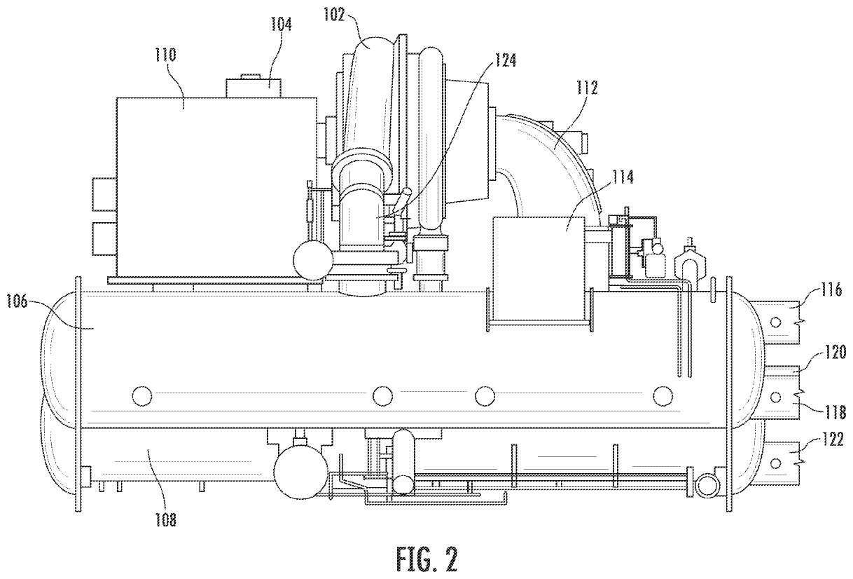

Referring now to FIGS. 1-2, an example implementation of a chiller assembly 100 is depicted. Chiller assembly 100 is shown to include a compressor 102 driven by a motor 104, a condenser 106, and an evaporator 108. A refrigerant is circulated through chiller assembly 100 in a vapor compression cycle. Chiller assembly 100 can also include a control panel 114 to control operation of the vapor compression cycle within chiller assembly 100.

Motor 104 can be powered by a variable speed drive (VSD) 110. VSD 110 receives alternating current (AC) power having a particular fixed line voltage and fixed line frequency from an AC power source (not shown) and provides power having a variable voltage and frequency to motor 104. Motor 104 can be any type of electric motor than can be powered by a VSD 110. For example, motor 104 can be a high speed induction motor. Compressor 102 is driven by motor 104 to compress a refrigerant vapor from evaporator 108 through suction line 112 and to deliver refrigerant vapor to condenser 106 through a discharge line 124. Compressor 102 can be a centrifugal compressor, a screw compressor, a scroll compressor, a turbine compressor, or any other type of suitable compressor. In each of the embodiments contemplated herein, compressor 102 is a multistage centrifugal compressor.

Evaporator 108 includes an internal tube bundle (not shown), a supply line 120 and a return line 122 for supplying and removing a process fluid to the internal tube bundle.

The supply line 120 and the return line 122 can be in fluid communication with a component within a HVAC system (e.g., an air handler) via conduits that that circulate the process fluid. The process fluid is a chilled liquid for cooling a building and can be, but is not limited to, water, ethylene glycol, calcium chloride brine, sodium chloride brine, or any other suitable liquid. Evaporator 108 is configured to lower the temperature of the process fluid as the process fluid passes through the tube bundle of evaporator 108 and exchanges heat with the refrigerant. Refrigerant vapor is formed in evaporator 108 by the refrigerant liquid delivered to the evaporator 108 exchanging heat with the process fluid and undergoing a phase change to refrigerant vapor.

Refrigerant vapor delivered by compressor 102 to condenser 106 transfers heat to a fluid. Refrigerant vapor condenses to refrigerant liquid in condenser 106 as a result of heat transfer with the fluid. The refrigerant liquid from condenser 106 flows through an expansion device and is returned to evaporator 108 to complete the refrigerant cycle of the chiller assembly 100. Condenser 106 includes a supply line 116 and a return line 118 for circulating fluid between the condenser 106 and an external component of the HVAC system (e.g., a cooling tower). Fluid supplied to the condenser 106 via return line 118 exchanges heat with the refrigerant in the condenser 106 and is removed from the condenser 106 via supply line 116 to complete the cycle. The fluid circulating through the condenser 106 can be water or any other suitable liquid.

The refrigerant can have an operating pressure of less than 400 kPa or approximately 58 psi, for example. In some embodiments, the refrigerant is R1233zd. R1233zd is a non-flammable fluorinated gas with low Global Warming Potential (GWP) relative to other refrigerants utilized in commercial chiller assemblies. GWP is a metric developed to allow comparisons of the global warming impacts of different gases, by quantifying how much energy the emissions of 1 ton of a gas will absorb over a given period of time, relative to the emissions of 1 ton of carbon dioxide.

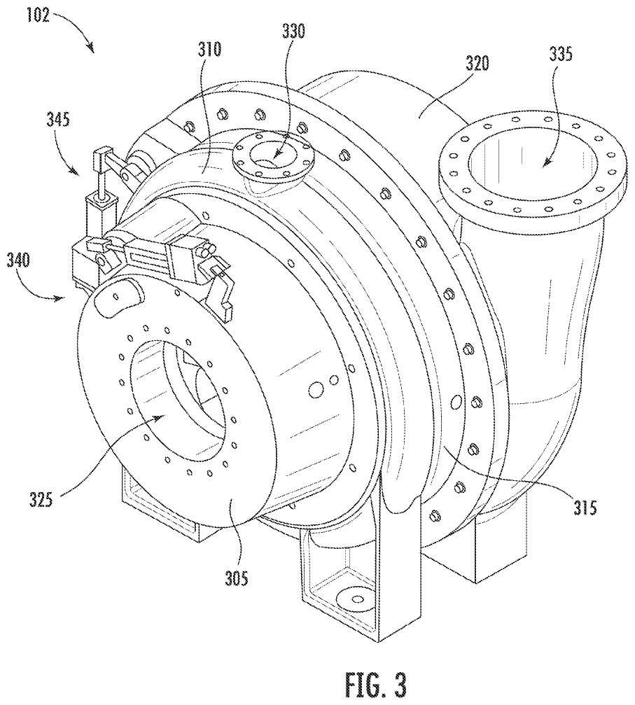

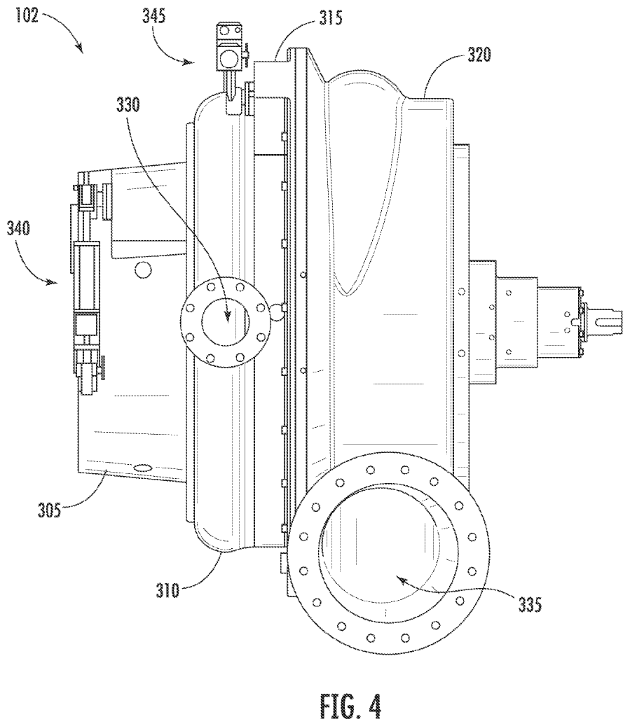

Referring now to FIGS. 3 and 4, perspective and top elevation views of a multistage compressor 102 are respectively depicted, according to some embodiments. The multistage compressor 102 is shown to include multiple structural components including, but not limited to, a main inlet passage housing 305, a secondary inlet collector housing 310, a transition region housing 315, and a volute outlet housing 320. Coupling of the main inlet passage housing 305, the secondary inlet collector housing 310, the transition region housing 315, and the volute outlet housing 320 can be achieved using any suitable method (e.g.; mechanical fasteners; welding). In various embodiments, one or more the housing components 305-320 can be fabricated from one or more subcomponents that are inseparably or detachably coupled to each other.

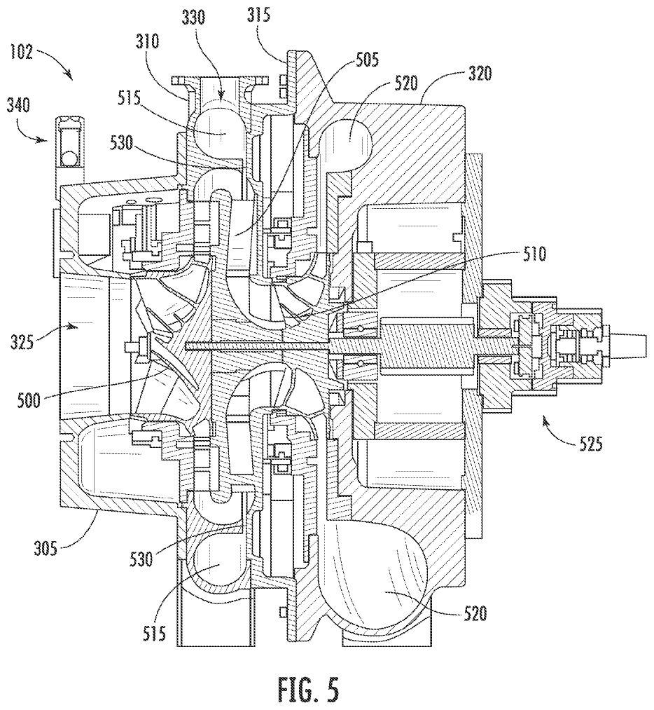

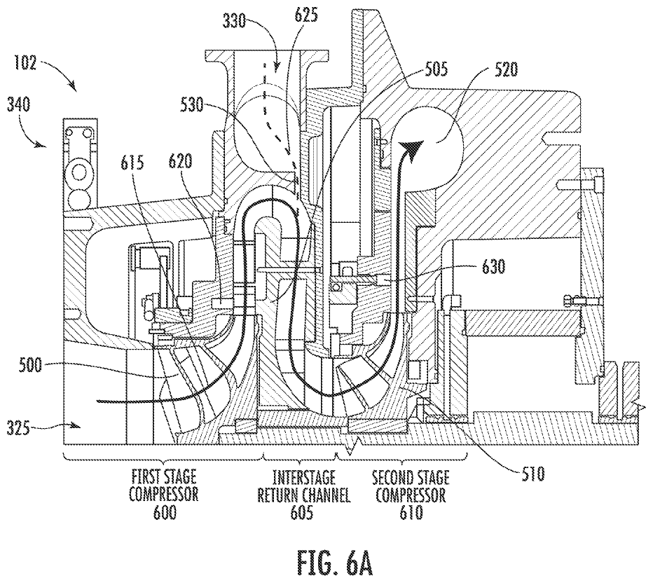

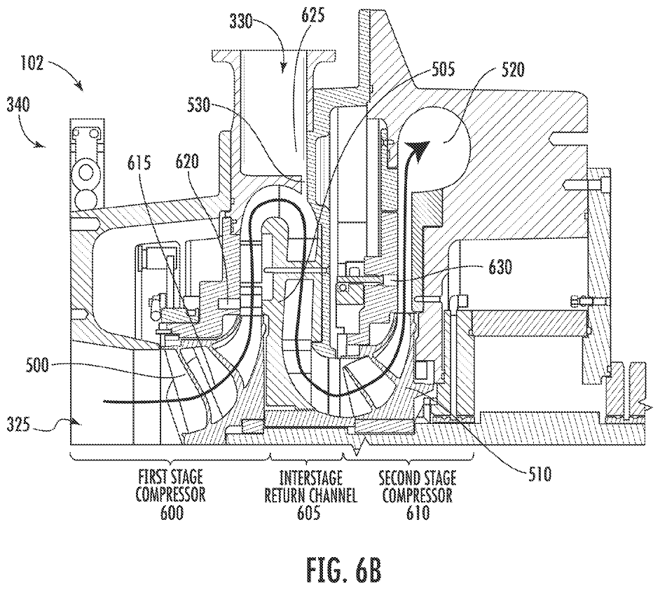

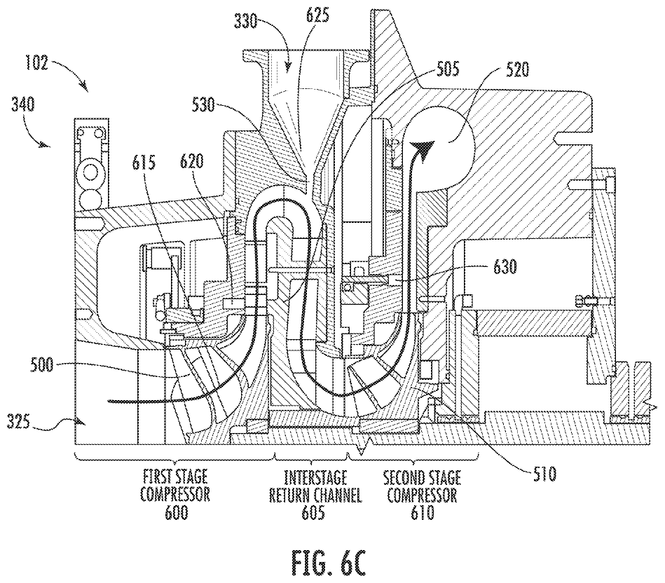

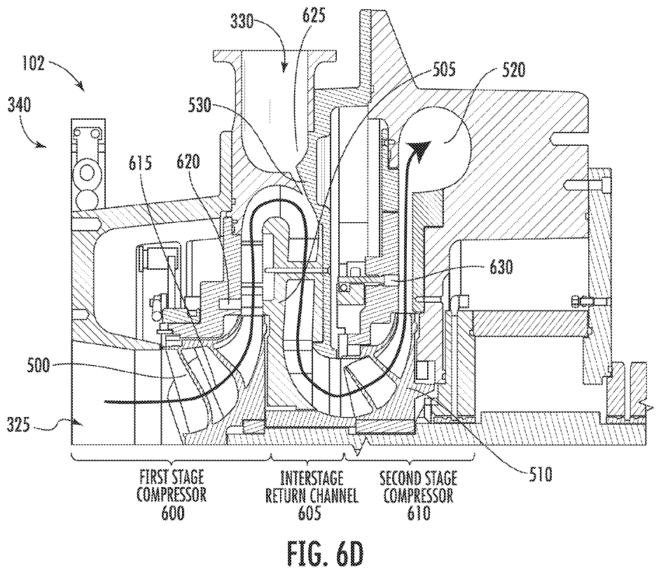

The main inlet passage housing 305 can include an inlet 325 that is coupled to a suction inlet pipe (e.g., suction line 112) that delivers a main supply of refrigerant vapor from an evaporator (e.g.; evaporator 108) to the multistage compressor 102. In some embodiments, the inlet 325 includes or is coupled to a flow straightening component (not shown) having multiple flow directing vanes. The flow straightening component may be positioned upstream of a first stage impeller (described in further detail below with reference to FIGS. 5 and 6) located within the main inlet passage housing 305 to ensure axial flow at the first stage impeller inlet, thereby increasing the performance of the compressor 102.

The main inlet passage housing 305 is shown to be coupled to the secondary inlet collector housing 310. The secondary inlet collector housing 310 can include an inlet 330 that is coupled to an economizer (not shown) to deliver a secondary supply of refrigerant vapor to the multistage compressor 102. An economizer is a type of sub-cooler that can provide increased capacity, efficiency, and coefficient of performance (COP) to the chiller assembly 100. An economizer circuit can include a flash tank, an inlet line to the flash tank that is connected to the condenser (e.g., condenser 106) or to a main refrigerant line downstream of the condenser, an expansion device incorporated into the inlet line, a first outlet line from the flash tank that is connected to the main refrigerant line upstream of the expansion device, and a second outlet line from the flash tank that is connected to the inlet 330 of the compressor 102. In operation, the economizer circuit can improve system efficiency by providing refrigerant vapor at an intermediate pressure through the inlet 330, thereby reducing the amount of work performed by the compressor 102 and increasing the efficiency of the compressor 102. As depicted in FIGS. 3 and 4, in some embodiments, the inlet 330 is situated at the top of the compressor 102 and the main and secondary inlets 325 and 330 are perpendicularly oriented relative to each other. However, the main and secondary inlets 325 and 330 can be oriented in various directions relative to each other depending on the intended application, such that the main and secondary inlets 325 and 330 may not be perpendicular relative to each other.

The secondary inlet collector housing 310 is shown to be coupled to the transition region housing 315. Secondary refrigerant flow provided by the economizer can flow circumferentially about the compressor before traveling through an insertion slot formed by the coupling of the secondary inlet collector housing 310 to the transition region housing 315. Once joined with the main refrigerant flow, the combined main and secondary refrigerant flows travel through a second stage impeller (described in further detail below with reference to FIGS. 5 and 6) housed within the transition region housing 315. The transition region housing 315 is also shown to be coupled to the volute outlet housing 320. The volute outlet housing 320 can include a flow passage extending circumferentially about the compressor and terminating in an outlet 335. The outlet 335 can be coupled to a discharge passage (e.g., discharge line 124) that delivers refrigerant vapor to a condenser (e.g., condenser 106). Although depicted as separate components in FIGS. 3 and 4, in other embodiments, two or more of the secondary inlet collector housing 310, the transition region housing 315, and the volute outlet housing 320 can be cast or machined as a single component.

The multistage compressor 102 is further shown to include a first diffuser actuating assembly 340 and a second diffuser actuating assembly 345. The first diffuser actuating assembly 340 can be configured to operate a first diffuser assembly downstream of the first impeller, while the second diffuser actuating assembly 345 can be configured to operate a second diffuser assembly downstream of the second impeller. In various embodiments, one or both of the diffuser assemblies can be a variable geometry diffuser (VGD) mechanism with a diffuser ring movable by the actuating assembly 340 or 345 between a first retracted position in which flow through a diffuser gap is unobstructed and a second extended position in which the diffuser ring extends into the diffuser gap to alter the fluid flow through the diffuser gap. In other embodiments, the multistage compressor 102 includes only a single diffuser actuating assembly. The single diffuser actuating assembly can control only the first stage of the compressor 102, only the second stage of the compressor 102, or both the first and second stages simultaneously.

Turning now to FIG. 5 and FIGS. 6A-6D, cross-sectional views of the multistage compressor 102 are depicted, according to some embodiments. As shown, refrigerant vapor from the suction line travels through the inlet 325 in the main inlet passage housing 305 and approaches a first impeller assembly 500. As specifically depicted in FIG. 6, the refrigerant vapor originating from the suction line can be designated the main refrigerant flow 615. During rotation, the impeller assembly 500 compresses and imparts tangential velocity to the main refrigerant flow 615 before directing it radially and tangentially outward to a diffuser assembly. The diffuser assembly decreases the radial and tangential velocity of the main refrigerant flow 615 and increases its static pressure. The diffusion process is controlled through operation of a first diffuser ring 620 by the first diffuser actuating assembly 340. In various embodiments, the diffuser can include vanes or it can be vaneless. The region extending from the inlet 325 through the exit of the first diffuser ring 620 comprises the first stage portion 600 of the multistage compressor 102.

After flowing past the first impeller assembly 500 and the first diffuser ring 620, the main refrigerant flow 615 turns axially and mixes with a secondary refrigerant flow 625. The secondary refrigerant flow 625 can be supplied by the economizer and can enter the multistage compressor 102 through the inlet 330. The secondary refrigerant flow 625 can flow through a circumferential collector passage 515 firmed in the secondary inlet collector housing 310 before joining with the main refrigerant flow 615. By traveling through the circumferential collector passage 515, the secondary refrigerant flow 625 is more uniformly distributed about the circumference of the compressor 102, which results in minimal disturbance when the secondary refrigerant flow 625 is joined with the main refrigerant flow 615. As shown, in some embodiments, the collector passage 515 has a substantially uniform (constant) cross-sectional area about the entire circumference of the compressor 102. In other embodiments, the cross-sectional area of the collector passage 515 may not be uniform about the circumference of the compressor 102. For example, the cross-sectional area of the passage can linearly or non-linearly increase or decrease as the refrigerant travels about the circumference of the compressor 102. Further, the cross-sectional area of the passage can be implemented using various different geometrical shapes.

A secondary flow insertion slot 530 fluidly couples the collector passage 515 to a directing vane assembly 505. After the secondary refrigerant flow 625 is distributed about the collector passage 515, it flows through the secondary flow insertion slot 530 extending around the full circumference of the compressor 102 to join with the main refrigerant flow 615. As the secondary flow insertion slot 530 is located in the region where the secondary inlet collector housing 310 is coupled to the transition region housing 315, the geometry of the secondary flow insertion slot 530 (i.e., length, width, insertion angle relative to other flow passages) is determined by the geometries of the secondary inlet collector housing 310 and the transition region housing 315, as well as the characteristics of the joint between the housing components 310 and 315. As shown in FIG. 6A, the secondary flow insertion slot 530 is substantially (i.e., ±10″) parallel to the flow path of the secondary inlet 330 and perpendicular to the flow path of the main inlet 325.

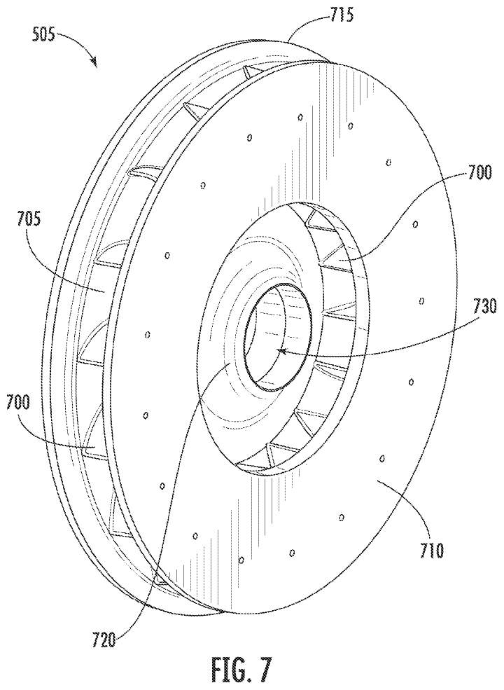

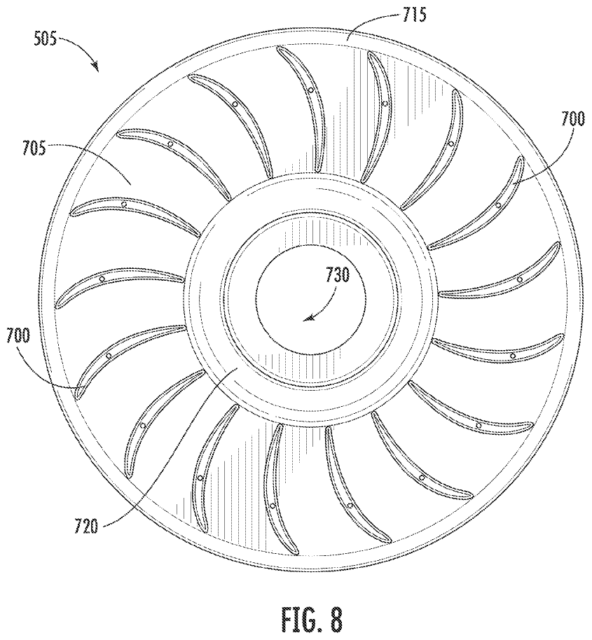

Upon combining, the main and secondary flows 615 and 625 pass through the directing vane assembly 505. As described in further detail below with reference to FIGS. 7 and 8, the directing vane assembly 505 can be configured to straighten and reduce the tangential velocity of component of the combined refrigerant flows 615 and 625. As specifically depicted in FIG. 6A, the region commencing from the exit of the first diffuser ring 620, encompassing the circumferential collector passage 515 and extending through the exit of the directing vane assembly 505 comprises the interstage return channel portion 605 of the multistage compressor 102.

After exiting the directing vane assembly 505, the combined main flow 615 and secondary flow 625 approaches a second impeller assembly 510. Similar to the first impeller assembly 500, the second impeller assembly 510 includes a rotating set of vanes that compresses and imparts tangential velocity to the combined main flow 615 and secondary flow 625. The rotation of the first impeller assembly 500 and the second impeller assembly 510 is driven by a drive connection 525 to a motor (e.g., motor 104). As shown in FIG. 5, drive connection 525 is a direct drive connection. In other embodiments, the drive connection 525 can include a gearbox or other transmission system.

The second impeller assembly directs the combined main flow 615 and secondary flow 625 to a diffuser assembly. The diffuser assembly decreases the radial and tangential velocity of the combined flow and increases its static pressure. In various embodiments, the diffuser assembly can be vaned or vaneless, depending on the application. The diffusion process is controlled through operation of a second diffuser ring 630 by the second diffuser actuating assembly 345. After passing through the diffuser gap region modulated by the second diffuser ring 630, the combined flow 615 and 625 enters a volute passage 520. In various embodiments, the cross-sectional area of the volute passage 520 may linearly or non-linearly increase or decrease as the refrigerant vapor travels from the exit of the diffuser ring 630 to the volute outlet 335 (described above with reference to FIGS. 3 and 4). For example, in an exemplary embodiment, the cross-sectional area of the volute passage 520 increases non-linearly as the refrigerant vapor travels toward the volute outlet 335. The region extending from the second impeller assembly 510 through the volute passage 520 comprises the second stage portion 610 of the multistage compressor 102, as specifically depicted in FIG. 6A.

While the cross-sectional shape of collector passage 515 is illustrated and described as circular with respect to FIG. 6A, it will be appreciated that the cross-sectional shape of collector passage 515 can be implemented using any shape that would satisfy mechanical and packaging requirements. A few examples of alternative cross-sectional shapes that can be used are illustrated, for example, in FIGS. 6B-6D. Referring specially to FIG. 6B, a rectangular shape for collector passage 515 is illustrated within inlet 330. Referring specially to FIG. 6C, a triangular shape for collector passage 515 is illustrated within inlet 330. Referring specially to FIG. 6D, an elliptical shape for collector passage 515 is illustrated within inlet 330. The collector passage 515 can also be positioned such that it is offset or symmetric with respect to secondary insertion slot 530.

Turning now to FIGS. 7 and 8, perspective and front cross-sectional views of directing vane assembly 505 are respectively depicted, according to some embodiments. Assembly 505 may alternatively be referred to as a “deswirl” vane assembly. Assembly 505 is shown to include multiple directing vanes 700 positioned between an upstream plate 705 and a downstream plate 710. The outer circumference of the upstream plate 705 is shown to include a rounded outer lip 715, while the inner circumference of the upstream plate 705 is shown to include a conical portion 720. In operation, a mixture of main refrigerant flow (e.g., main flow 615) and secondary refrigerant flow (e.g., secondary flow 625) combines and flows from a region surrounding the rounded outer lip 715, past the directing vanes 700, along the conical portion 720, and through a central opening 730 in the downstream plate 710 before approaching a second impeller (e.g., second impeller assembly 510). Since the secondary flow 625 is distributed about collector passage 515 (depicted in FIG. 5) before combining with the main flow 615, destabilizing disruptions to the main flow 615 are minimized.

As depicted specifically in FIG. 8, the directing vanes 700 are shown to have a substantially airfoil-like shape. Although directing vane assembly 505 is shown to include seventeen directing vanes 700, vane assembly 505 can include any number of directing vanes, having any desired vane shape or geometry based on the operating characteristics of the multistage compressor 102 (e.g., compressor operating pressure). In some embodiments, the orientation of the directing vanes 700 may be fixed relative to the upstream plate 705 and the downstream plate 710. In other embodiments, the directing vane assembly 505 can include an actuating assembly used to modify the orientations of the directing vanes 700.

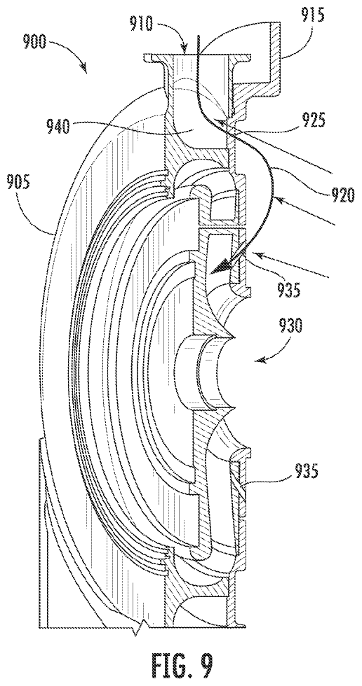

Referring now to FIG. 9, another embodiment of an interstage return channel assembly 900 that can be utilized in the multistage compressor 102 is depicted. Assembly 900 is shown to include a secondary inlet collector housing 905 coupled to a transition region housing 915. In contrast to the embodiment depicted in FIGS. 5-6, the assembly 900 is shown to include a modified flow path for a secondary flow of fluid 920 provided from an economizer. Instead of traveling through a flow passage that is formed by the joint of the secondary inlet collector housing 905 and the transition region housing 915, the transition region housing 915 is shown to include a secondary flow outlet 925 and a secondary insertion slot 935. Both the secondary flow outlet 925 and the secondary insertion slot 935 may extend about the entire circumference of the compressor 102.

Upon entering the inlet collector housing 905 through the inlet 910, the secondary, flow of fluid 920 is distributed circumferentially about the multistage compressor 102 by the collector passage 940. The secondary flow 920 then exits through the secondary flow outlet 925 before flowing through the secondary insertion slot 935 into a directing vane assembly 930, where the secondary flow 920 is combined with the main flow (not shown). Unlike the secondary insertion slot 530, the secondary insertion slot 935 is not parallel to the inlet 910. Instead, the secondary insertion slot 935 is situated at an angle relative to the inlet 910. Although the secondary refrigerant vapor flow path provided by the interstage return channel assembly 900 causes less disruption to the main refrigerant vapor flow and therefore results in better aerodynamic performance than the arrangement depicted in FIGS. 5-6, the assembly 900 requires a greater axial flow length and therefore may not be preferred where the overall axial length of the compressor 102 is constrained.

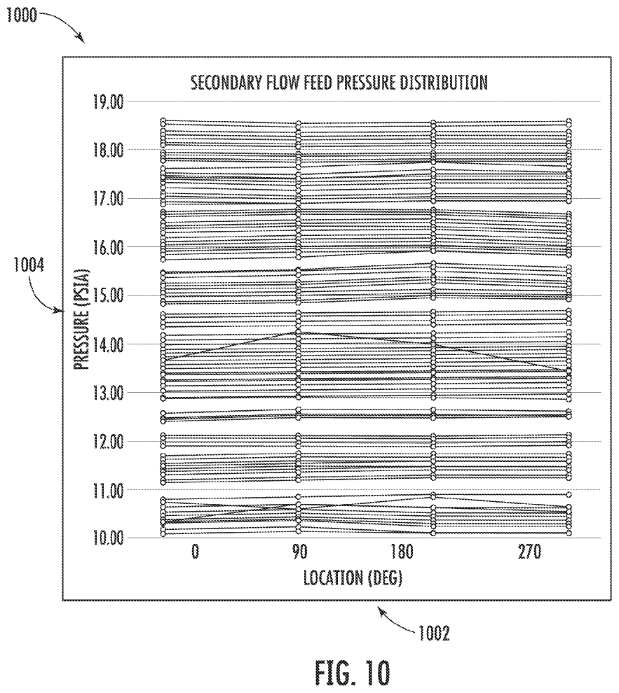

Taming now to FIG. 10, a plot 1000 depicting circumferential pressure distribution test data for the multistage compressor 102 is shown, according to some embodiments. The x-axis 1002 is representative of the locations of pressure measurement devices positioned in the secondary flow insertion slot 530 in units of degrees. For example, the 0 degree location may correspond with the position of the inlet 330, while the 180 degree location may be positioned opposite the inlet 330. The y-axis 1004 is representative of pressure measurements in units of pounds per square inch absolute (psia). Each of the lines of plot 1000 depicts the results of an independent test run (i.e., plot 1000 depicts the results of several independent test runs). As shown, the test data demonstrates that the circumferential pressure discrepancy between the maximum and minimum pressure measurement for each test run is less than 0.2% of the average pressure value. By contrast, multistage compressors not utilizing the optimized interstage inlet of the present disclosure have non-uniformity in the pressure distribution in the range of 1% or more. Greater circumferential uniformity in the secondary flow results in improved chiller performance.

The construction and arrangement of the systems and methods as shown in the various exemplary embodiments are illustrative only. Although only example embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the examples provided without departing from the scope of the present disclosure. WHAT IS CLAIMED IS:

1. A compressor; comprising:
a first stage portion comprising a first impeller assembly and a first diffuser assembly;
a second stage portion comprising a second impeller assembly and a second diffuser assembly; and
air interstage portion situated between the first stage portion and the second stage portion and comprising:
a directing vane assembly;
a collector passage surrounding the directing vane assembly; and
a circumferential insertion slot fluidly coupling the collector passage with the directing vane assembly.

2. The compressor of claim 1, wherein the first stage portion further comprises a main inlet configured to deliver a main flow of fluid to the first impeller assembly.

3. The compressor of claim 2, wherein the interstage portion further comprises a secondary inlet configured to deliver a secondary flow of fluid to the collector passage.

4. The compressor of claim 3, wherein the main inlet and the secondary inlet are perpendicularly oriented relative to each other.

5. The compressor of claim 3, wherein the compressor operates as part of a chiller assembly, the main inlet fluidly coupled to an evaporator and the secondary inlet fluidly coupled to an economizer.

6. The compressor of claim 3, wherein the circumferential insertion slot and the secondary inlet are parallel relative to each other.

7. The compressor of claim 3, wherein the circumferential insertion slot is oriented at an angle relative to the secondary inlet.

8. The compressor of claim 3, wherein each of the main flow of fluid and the secondary flow of flow fluid is a refrigerant.

9. The compressor of claim 8, wherein the refrigerant is R1233zd.

10. The compressor of claim 1, wherein a cross-sectional area of the collector passage is constant about a circumference of the compressor.

11. The compressor of claim 1, wherein the first diffuser assembly comprises a first diffuser ring movable by a first actuating assembly, and the second diffuser assembly comprises a second diffuser ring movable by a second actuating assembly.

12. The compressor of claim 1, further comprising a volute passage situated at an exit of the second diffuser assembly.

13. A compressor, comprising:
a first stage portion comprising a first impeller assembly and a first diffuser assembly;
a second stage portion comprising a second impeller assembly and a second diffuser assembly; and
an interstage portion situated between the first stage portion and the second stage portion and comprising:
a directing vane assembly;
a collector passage surrounding the directing vane assembly; and
a circumferential insertion slot fluidly coupling the collector passage with the directing vane assembly; and
a main inlet configured to deliver a main flow of fluid to the first impeller assembly.

14. The compressor of claim 13, wherein the interstage portion further comprises a secondary inlet configured to deliver a secondary flow of fluid to the collector passage.

15. The compressor of claim 14, wherein the main inlet and the secondary inlet are perpendicularly oriented relative to each other.

16. The compressor of claim 14, wherein the circumferential insertion slot and the secondary inlet are parallel relative to each other.

17. The compressor of claim 14, wherein the circumferential insertion slot is oriented at an angle relative to the secondary inlet.

18. A compressor; comprising:
a first stage portion comprising a first impeller assembly and a first diffuser assembly;
a second stage portion comprising a second impeller assembly and a second diffuser assembly; and
an interstage portion situated between the first stage portion and the second stage portion and comprising
a directing vane assembly;
a collector passage surrounding the directing vane assembly; and
a circumferential insertion slot fluidly coupling the collector passage with the directing vane assembly;
a main inlet configured to deliver a main flow of fluid to the first impeller assembly; and a secondary inlet configured to deliver a secondary flow of fluid to the collector passage.

19. The compressor of claim 18, wherein a cross-sectional area of the collector passage is constant about a circumference of the compressor.

20. The compressor of claim 18, further comprising a volute passage situated at an exit of the second diffuser assembly.
